(19) United States
(12) Patent Application Publication
(10) Pub. No.: US 2007/0228679 A1
(43) Pub. Date: Oct. 4, 2007

(54) Tilt Dolly Used for Transporting Landscaping Materials

(76) Inventor: William P. Westrate, Cassopolis, MI (US)

Correspondence Address: MILLER JOHNSON SNELL CUMMISKEY, PLC, 800 CALDER PLAZA BUILDING, 250 MONROE AVE N W, GRAND RAPIDS, MI, 49503-2250, US

(21) Appl. No.: 11/278,288

(22) Filed: Mar. 31, 2006

(51) Int. Cl. B62B 1/00

(52) U.S. Cl. 280/47.26

(57) ABSTRACT

A tilt dolly (200) for use in transporting landscaping materials includes a substantially square frame (201, 203, 211, 213, 217, 219) having a first end and a second end. A first set of wheels (301, 303) and second set of wheels (305, 307) are attached at predetermined positions on the substantially square frame such that the center of gravity of the tilt dolly is in a substantially forward direction toward the first end enabling the tilt dolly (300, 400) to be easily tilted in a reverse direction. A tilt rail assembly (205, 210) is fastened to the frame at a predetermined angle on the second end for allowing the square frame to be tilted enabling it to tilt in a semi-tilted and fully tilted position for preventing stress and wind damage when transporting trees at highway speeds.

### FIELD OF THE INVENTION

The present invention relates a transportation dolly and more particularly to a tilt dolly for tilting a large tree during transportation.

### BACKGROUND

Carts and dollies used for transporting heavy objects are well known in the art. Dollies are particularly used in the landscaping trade in view of the heavy weight of trees, plants and shrubs that are often transported from place to place on a job site. Prior art FIG. 1 illustrates a landscaping dolly 100 that is currently used in the art. The dolly 100 includes base 101 and upright frame 103 supported by braces 105. Handles 107 are used by the operator to position the base 101 under the tree where it is then tilted using wheels 109 such that the tree or other objects are lifted from the ground. The operator then pushes the object to a desired location where the load is removed.

The problem associated with the prior art dolly 100 is that it is difficult to use during the tree transplantation process. Moving trees either on the ground or to a transportation trailer can require multiple laborers using this device. Those skilled in the art will recognize that once a tree is positioned on the base 101, it is cumbersome to move to another location, In some cases it may not even fit within the dolly 100. With regard to tree transplantation, not only is it difficult to push great amounts of weight but the tree and root ball must be balanced in the dolly in order to prevent it from tipping side to side. In situations where the tree is tall, it can inadvertently catch on overhead wires and tree limbs. When it is used in connection with a vehicular trailer, the prior art dolly has no means that allow it to be tilted during transport. For example, if a deciduous tree is not tilted downwind at high transport speeds, the wind forces can pull all the leaves from the tree, not to mention the high stresses put on the tree branches. Accordingly, the need exist to provide a dolly that can easy be pushed or pulled onto a transportation trailer and can be positioned in both an upright or tilted position during transport.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is an illustration of a landscaping dolly as used in the prior art.

FIG. 2 is a side perspective view of the tilt dolly resting on wheel casters in accordance with an embodiment of the invention.

FIG. 3 is side perspective view of the tilt dolly resting in a partial tilted position in accordance with an embodiment of the invention.

FIG. 4 is a side perspective view of the tilt dolly resting in a fully tilted position in accordance with an embodiment of the invention.

FIG. 5 is a side perspective view of the tilt dolly with root ball carrier device inserted inside the dolly.

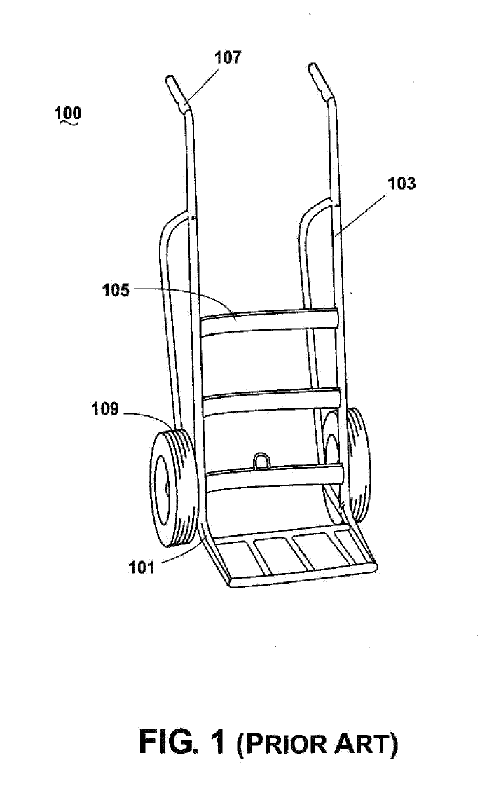

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to a tilt dolly used for transporting large trees. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

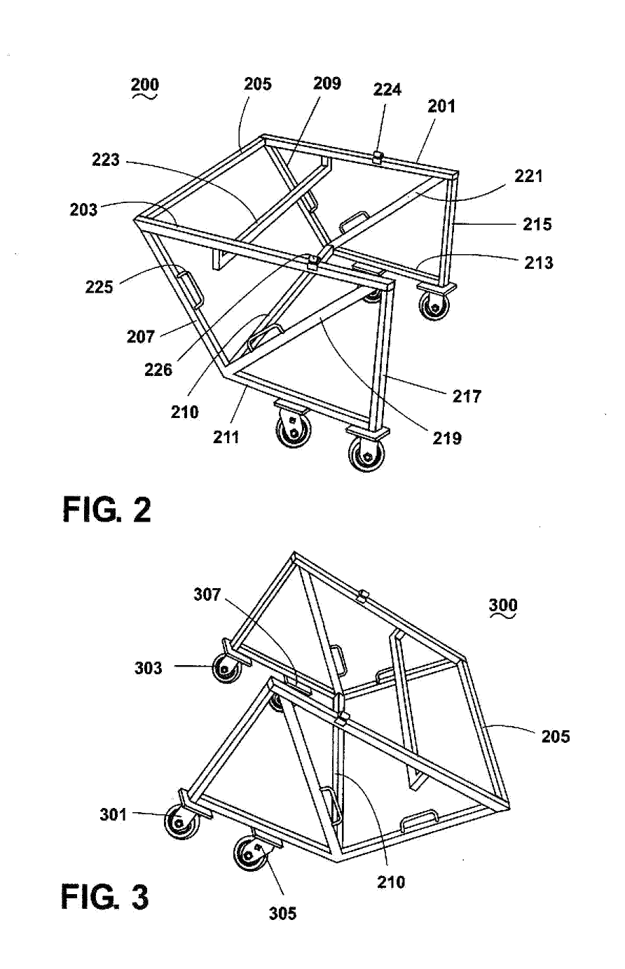

FIG. 2 illustrates a tilt dolly 200 which is formed into an open frame platform for transporting large conifer and deciduous trees. The tilt dolly 200 includes top rails 201, 203 connected by a back tilt rail 205 and side tilt rails 207, 209. The side tilt rails 207, 209 slope downwardly and attach with bottom rails 211, 213 and support rail 210. The bottom rails 211, 213 extend laterally and attach to front rails 215, 217, respectively. The top rails 201, 203, bottom rails 211, 213 and front rails 215, 217 and side tilt rails 207, 209 form a cubical box-like structure that is supported by side braces 219, 221. Side braces 219, 221 extend substantially diagonally between the top rails 201, 203 and the bottom rails 211, 213. A top brace 223 extends across the top rails 201, 203 in order to provide lateral support for the tilt dolly 200.

In operation, the tilt dolly 200 is used with a root ball carrier device such as a U-BALL or the like which acts to surround a tree root ball enabling the roots and surrounding ball to be wrapped and contained. Once contained within the carrier device it can be positioned with the tilt dolly 200 enabling it to be moved and/or positioned in a tilted positioned during transport. In order to fasten the root ball carrier device inside the tilt dolly 200, the side tilt rails 207, 209 and the side braces 219, 221 may include one or more attachment fasteners or loops 224, 226 which can be used to hold the dolly into a fixed position. A plurality of handles 225 are used to move or tie down the dolly into a fixed position. Additionally, the top brace 223 faces downwardly from the top rails 201, 203 which also works to prevent the root ball carrier device from moving in a rearward direction during transport.

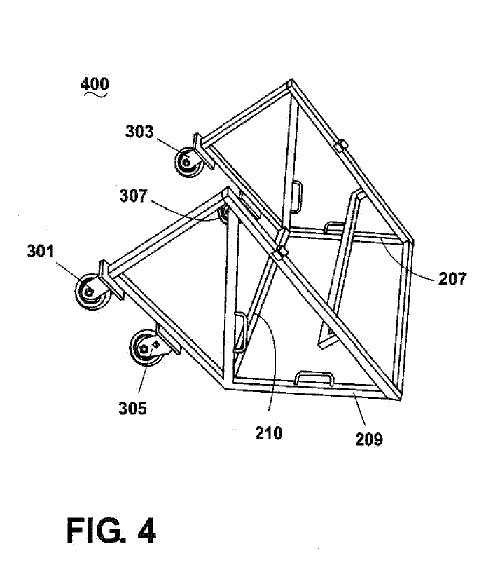

FIG. 3 illustrates the tilt dolly 300 in a partially tilted position. A plurality of forward caster wheels 301, 303 and rearward caster wheels 305, 307 are positioned at predetermined points on the bottom rails 211, 213 which allow the tilt dolly 200 to easily tilt into a rearward position. When the weight of a tree is positioned within the tilt dolly 200, the rearward caster wheels 305, 307 are positioned forward of the center of gravity which allows the dolly to be easily tilted in a rearward direction by moving the back tilt rail 205. As seen in FIG. 2, the rearward caster wheels are positioned at substantially the center of the bottom rails 211, 213. Thus, when a tree is positioned in the dolly, the fulcrum of the dolly is rearward in view of the positioning of the forward caster wheels 301, 303 and the rearward caster wheel 305, 307. This allows the support rail 210 to rest across the ground for providing support while the forward caster wheels 301, 303 are in a raised position. This orients the tilt dolly 300 in a partially tilted position where a conifer or deciduous tree (not shown) can be slanted or tilted downwind during the transportation process. This relieves stress on both the trunk and branches as well as allowing the tree to retain its leaves and needles during transport at highway speeds.

FIG. 4 illustrates the tilt dolly 400 situated in a fully tilted position. In the fully tilted position, the side tilt rails 207, 209, support rail 210 and the back tilt rail 205 are oriented to make contact with the ground in order to provide enhanced support. The forward caster wheels 301, 303 and the rearward caster wheels 305, 307 are in a raised position such that they make no ground contact. The tilt dolly 400 as used in the fully tilted position can be particularly useful in tree transplantation where a heavy tree root ball must be removed from the tilt dolly. During this process, the tilt dolly can be lowered into its fully tilted position where the tree root ball can be rotated on its root ball into a position that allows the tilt dolly to be pulled from under the root ball. Thereafter, the root ball can be moved into a transplantation hole or the like.

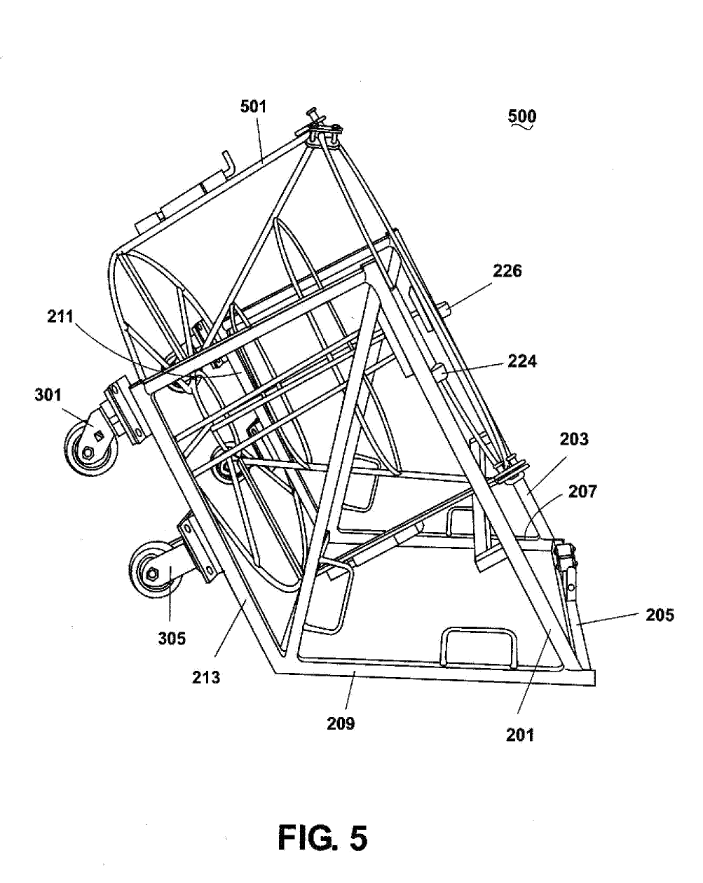

FIG. 5 illustrates the tilt dolly 500 which includes a root ball carrier device 501 inserted therein. The tilt dolly 500 is shown in a fully tilted position like that in FIG. 4, where the root ball carrier device 501 is positioned between the top rails 201, 203 and bottom rails 211, 213 where it abuts the top brace 223 and is frictionally engaged within the dolly. This enables the root ball carrier device 501 to be easily transported by the tilt dolly 500. The root ball carrier device is fully disclosed in U.S. patent application Ser. No. 11/092,255 entitled Tree Root Ball Wrapping Apparatus and Method of Using Same, which is herein incorporated by reference.

Thus, the invention describes a framed tilt dolly used for transporting and transplanting substantially large conifer and deciduous trees. The tilt dolly includes a plurality of wheel casters which are positioned in a predetermined position for allowing the tilt dolly to be tilted into a partially tilted and fully tilted position. This allows the tilt dolly to be used to prevent stress on the trees during transportation as well as allowing the dolly to be easily removed during the tree transplantation process.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

I claim:

1. A tilt dolly for use in transporting landscaping materials comprising:
a substantially square frame having an first end and a second end;
a plurality of wheels attached at a predetermined position on the substantially square frame such that the center of gravity of the tilt dolly is in a substantially forward direction toward the first end; and
a tilt rail assembly fastened to the square frame at a predetermined angle on the second end for allowing the square frame to be tilted enabling it to rest in at least one position toward the second end.

2. A tilt dolly for use in transporting landscaping materials as in claim 1, wherein the substantially square frame engages with a root ball carrier device for containing a tree root ball inside the tilt dolly.

3. A tilt dolly for use in transporting landscaping materials as in claim 1, further comprising at least one fastener attached to the tilt rail assembly for engaging a root ball carrier device.

4. A tilt dolly for use in transporting landscaping materials as in claim 1, further comprising a top brace attached across the substantially square frame for holding the root ball carrier device in a fixed position.

5. A tilt dolly for use in transporting landscaping materials as in claim 1, wherein the tilt dolly rests against the ground in both a semi-tilted position and fully-tilted position.

6. A tilt dolly for positioning trees in a tilted manner during transportation comprising:
a open frame platform having an open end;
a tilt rail assembly angularly attached to the rear of the open frame platform for allowing the open frame platform to tilt in a direction opposite of the open end;
a first set of wheels attached to the open frame platform at the open end;
a second set of wheels attached to open frame platform at a position allowing the center of gravity of the platform to remain substantially forward in a direction toward the open end; and
at least one engagement fastener positioned within the open frame platform for engaging with a root ball carrier device.

7. A tilt dolly for positioning trees in a tilted manner as in claim 6, wherein the wheels are caster wheels.

8. A tilt dolly for positioning trees in a tilted manner as in claim 6, further comprising at least one brace extending across a portion of the open flame platform for preventing movement of the root ball carrier device.

9. A tilt dolly for positioning trees in a tilted manner as in claim 6, wherein the tilt rail assembly can be positioned against the ground for enabling the tilt dolly to lie in a fully tilted position.

10. A tilt dolly for use in transporting substantially large trees comprising:
an open frame substantially square in shape having an open end and a closed end;
a tilt rail assembly forming the closed end of the open frame for tilting the open frame in at least one tilted position;
a first set of wheels attached to open frame assembly at the open end;
a second set of wheels attached to the open frame at a position enabling the center of gravity of the open frame to remain substantially forward;
a brace extending across the open frame for preventing movement of a root ball carrying device; and
at least one engagement fastener attached to the tilt rail assembly for attaching to the root ball carrying device for holding it into a fixed position.

11. A tilt dolly as in claim 10, wherein the at least one tilted position includes a semi-tilted position and a fully tilted position.

12. A tilt dolly as in claim 10, wherein the open frame includes a plurality of side braces extending substantially diagonally across the open frame for increasing the stability of the tilt dolly.

13. A tilt dolly as in claim 1, wherein the first set of wheels and the second set of wheels are caster wheels.
